(19) United States
(12) Patent Application Publication
(10) Pub. No.: US 2008/0185950 A1
(43) Pub. Date: Aug. 7, 2008

(54) Electric Lamp With Electrode Rods Having Longitudinal Grooves

(75) Inventors: Peter Claus, Turnhout (BE); Ger Van Hees, Turnhout (BE); Jan De Laet, Turnhout (BE); Luc Smets, Turnhout (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/815,110

(22) PCT Filed: Jan. 24, 2006
(86) PCT No.: PCT/IB06/50254

§ 371 Date: Jul. 31, 2007

(30) Foreign Application Priority Data
Feb. 4, 2005 (EP) 05100794.6

(51) Int. Cl. H01J 1/88; H01J 9/14

(52) U.S. Cl. 313/267; 445/49

(57) ABSTRACT

An electric lamp provided with a bulb (1) of quartz glass and a metal electrode rod (3;21,22). The electrode rod (3;21,22) is at least partly embedded in the quartz glass material of the bulb. At least a major part of the surface of the electrode rod (3;21,22) that is in contact with the quartz glass material is provided with grooves (6) having a substantially longitudinal direction.

The invention is related to an electric lamp provided with a bulb of quartz glass and a metal electrode rod, which electrode rod is at least partly embedded in the quartz glass material of the bulb. In general, two electrode rods are embedded in the quartz glass material of the bulb of the lamp. Such a lamp, for example a high pressure mercury discharge lamp, may have a gas pressure of about 200 bar up to 500 bar during normal operation, and may consume an electric power in the range of 50 W-500 W, or even up to 1500 W.

A lamp of this kind is disclosed in GB-A-2351602. This publication describes a gas discharge lamp comprising a quartz glass bulb enclosing the light emitting discharge space of the lamp, and having pinch sealed portions formed at each of the two ends of the quartz glass bulb. The ends of two tungsten electrode rods project into the discharge space. A portion of each electrode rod is embedded in a pinch sealed portion, in such a manner that the two electrode rods are positioned coaxially with respect to each other. The other ends of the two electrode rods are connected to the ends of conductive molybdenum foil members in order to supply electric current to the electrode rods, which molybdenum foil members are also embedded in the pinch sealed portions of the quartz glass bulb of the lamp. The other ends of the molybdenum foil members are connected to lead wires, which lead wires extend outside the quartz glass bulb of the lamp.

The two electrode rods can be positioned coaxially at both ends of the bulb, but they can also be positioned parallel to each other and at some distance from each other; in the latter case they are embedded in the same pinch sealed portion of the quartz glass bulb of the lamp. The lamp can be an integral part of a unit comprising a lamp and a reflector.

In such lamps there is a difference in thermal expansion between the material of the electrode rods and the quartz glass material, which material surrounds a part of the electrode rods in the pinch sealed portion of the bulb of the lamp. Such difference in thermal expansion causes high stresses in the materials of the lamp when the lamp is in use, and the high stresses may result in early lamp failure due to cracking or explosion of the bulb of the lamp. Several measures are known in order to limit the detrimental effects of said difference in thermal expansion, like applying coils around the electrode rods, or applying foils wrapped around the electrode rods, etc. A disadvantage of these measures is the relatively high additional costs, and most of these measures require additional parts in the lamp.

An object of the invention is a lamp provided with a bulb of quartz glass and a metal electrode rod, wherein the electrode rod is at least partly embedded in the quartz glass material of the bulb, and wherein the risk of failures due to the difference in thermal expansion between the material of the electrode rod and the quartz glass material is reduced.

In order to achieve this objective, at least a major part of the surface of the electrode rod that is in contact with the quartz glass material is provided with grooves having a substantially longitudinal direction, i.e. the grooves are directed substantially parallel to the axis of the electrode rod. In a preferred embodiment, substantially the whole surface of the electrode rod that is in contact with the quartz glass material is provided with said grooves. In general, there are two electrode rods present in the lamp, and preferably both electrode rods are provided with said substantially longitudinal grooves.

The presence of the longitudinal grooves on the surface of the electrode rod means that the roughness Ra of the surface, measured in the circumferential (tangential) direction of the electrode rod, is greater than the roughness of the surface of the electrode rod measured in the longitudinal (axial) direction of the electrode rod. Preferably, the roughness measured in the circumferential direction is more than double, more preferably more than 5 times, the roughness measured in the longitudinal direction.

In a preferred embodiment, the metal material of the electrode rod comprises tungsten for at least 70% by weight. The metal material of the electrode rod may contain one or more additive dopants up to 30% by weight, for example the metals yttrium, thorium, molybdenum, rhenium, lanthanum, cerium, aluminum, potassium, niobium, chromium and/or oxides of these metals. Such dopants positively influence the yield/tensile strength of the electrode rods. Alternatively, the electrode rods may consist of pure tungsten. Furthermore, the electrode rods, and also the molybdenum foil member, may be provided with an oxidation protecting coating like a chromium metal layer.

In a preferred embodiment, the depth of the grooves is more than 1 μm, preferably between 2 μm and 30 μm, more preferably between 3 μm and 20 μm, and still more preferably between 5 μm and 10 μm. Experience has shown that such depths of the grooves result in a substantial reduction of the risk of failures due to the difference in thermal expansion between the material of the electrode rod and the quartz glass material of the bulb of the lamp.

In a preferred embodiment, the width/depth ratio of the grooves is less than 4, preferably less than 2, more preferably less than 1. Experience has also shown that such width/depth ratios of the grooves result in a substantial reduction of the risk of failures due to the difference in thermal expansion between the material of the electrode rod and the quartz glass material of the bulb of the lamp.

In general, the diameter of the electrode rod is between 0.05 mm and 0.5 mm, but it can also be up to 2.5 mm. In a preferred embodiment, the number of grooves in a cross section of the electrode rod is between 10 and 4000 times the diameter of the electrode rod measured in mm, preferably between 100 and 2000 times, and more preferably between 250 and 1000 times the diameter of the electrode rod measured in mm. Experience has shown that such numbers of grooves at the surface of the electrode rods result in a substantial reduction of the risk of failures due to the difference in thermal expansion between the material of the electrode rods and the quartz glass material of the bulb of the lamp.

Good results are obtained in experiments where the grooves are evenly distributed around the circumference of the electrode rod, but a less even distribution also gives positive results. Preferably, in a cross section of the electrode rod, the grooves are circumferentially distributed at angles of (360/n)° plus or minus (360/2n)°, where n is the number of grooves in said cross section.

The grooves have a substantially longitudinal direction with respect to the electrode rod, i.e. the grooves are directed substantially parallel to the axis of the electrode rod. In a preferred embodiment, the angles between the longitudinal axis of the electrode rod and the grooves are less than 20°, preferably less than 10°, more preferably less than 4°.

Preferably, the lamp is a high pressure gas discharge lamp, because failures due to the difference in thermal expansion between the material of the electrode rod and the quartz glass material occur in particular in such lamps. However, the invention can also successfully be applied in other lamps, such as metal-halide gas discharge lamps, e.g. MSR (comprising mercury, metal-halides of Rare-earths like Scandium-Bromide-iodide-chloride, and consuming power in the range of 100 W to 10,000 W during stable operation), or LV/MV halogen incandescent lamps having electrode rods to which a tungsten filament as the light source is connected.

In a preferred embodiment, the electrode rod is present in the pinch sealed portion of the quartz glass bulb of the lamp, wherein the bulb can have one pinch sealed portion or two pinch sealed portions, i.e. a pinch sealed portion at each of the two ends of the bulb. In case two pinch sealed portions are present, each pinch sealed portion can be provided with an electrode rod.

The invention is also related to a unit of a lamp and a reflector, wherein the reflector is provided with a lamp as described above. The reflector is an integral part of the lamp assembly, so that the whole unit must be replaced in case of failure of the lamp. Therefore, reduction of the risk of lamp failure is particularly important.

The invention is furthermore related to a method of manufacturing an electric lamp provided with a bulb of quartz glass and a metal electrode rod, wherein a part of the electrode rod is embedded in the quartz glass material of the bulb, and wherein, before the electrode rod is embedded in the quartz glass material, at least a major part of the surface of the electrode rod that will be in contact with the quartz glass material is provided with grooves having a substantially longitudinal direction.

In order to provide the surface of the electrode rod with longitudinal grooves, preferably, the electrode rod is subjected to a wire drawing process, whereby the material of the electrode rod undergoes a plastic deformation. Thereby, longitudinally directed grooves will be created at the surface of the electrode rod. The longitudinal grooves can also be manufactured by means of a grinding process, an etching process, or by means of a material-removing laser beam operation.

The invention will now be further elucidated by means of a description of an electric lamp provided with a bulb of quartz glass having two pinch sealed portions and two tungsten electrode rods embedded in said pinch sealed portions. Therein, reference is made to the drawing comprising Figures which are only schematic representations, in which:

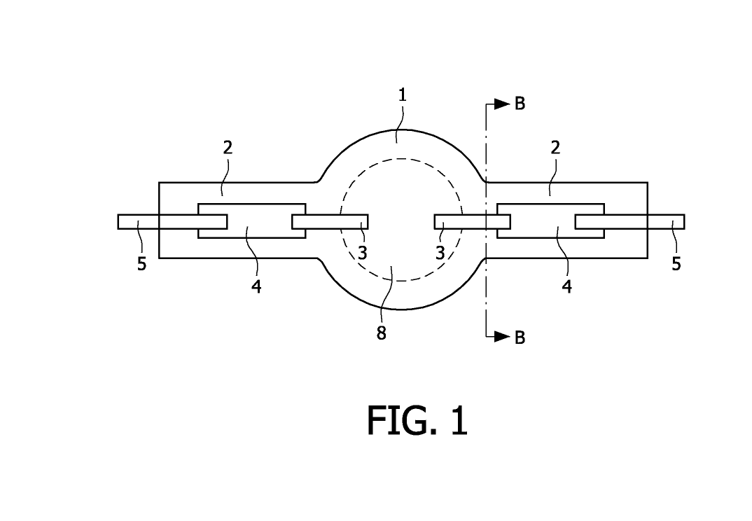

FIG. 1 shows a high pressure gas discharge lamp;

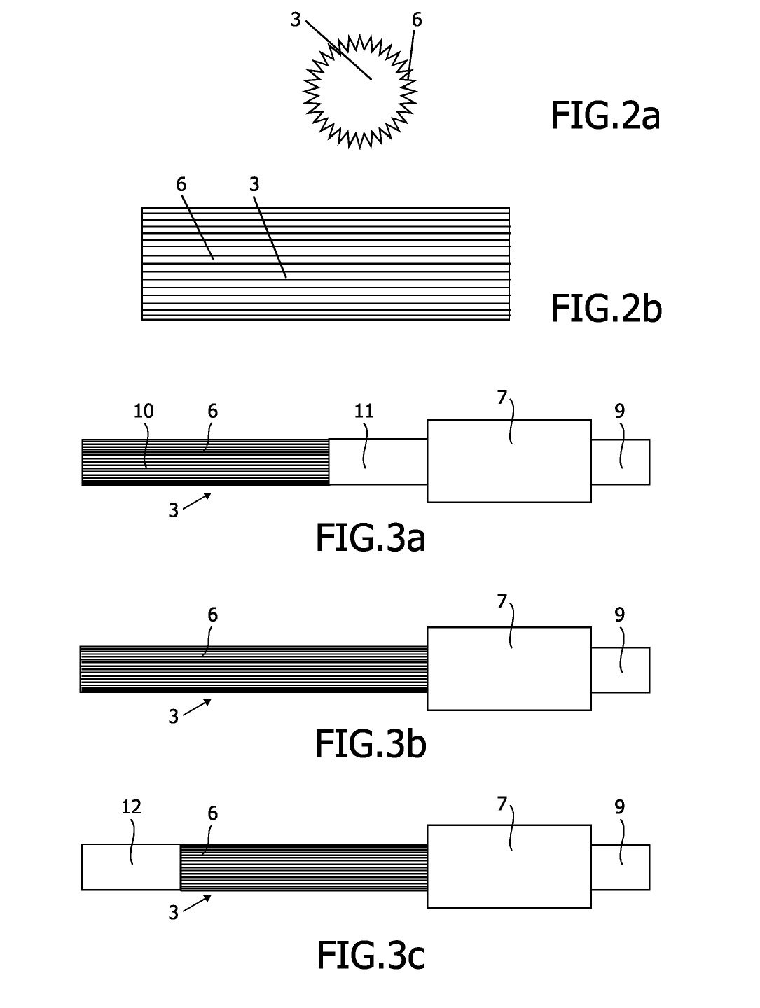

FIG. 2a is a sectional view of an electrode rod;

FIG. 2b is a side view of the electrode rod of FIG. 2a;

FIGS. 3a, 3b and 3c are views of an electrode rod provided with an electrode coil; and

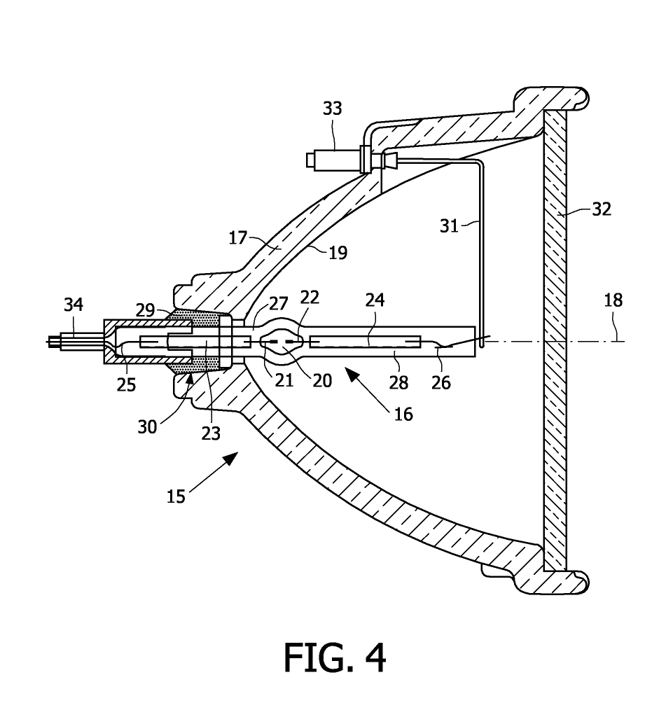

FIG. 4 is a sectional view of a lamp assembly.

FIG. 1 shows a high pressure mercury gas discharge lamp having a bulb 1 of transparent quartz glass material. The quartz glass bulb 1 encloses a gas discharge space 8, indicated by means of a dashed line. At both ends, the quartz glass bulb 1 is closed by means of a pinch sealed portion 2, after the gas discharge space 8 has been provided with the required gas filling. There are two coaxially positioned tungsten electrode rods 3, and one end of each electrode rod 3 extends into the gas discharge space 8. The other ends of the electrode rods 3 are connected to the ends of conductive molybdenum foil members 4.

A part of the tungsten electrode rods 3 and the molybdenum foil members is embedded in the pinch sealed portions 2 of the quartz glass bulb 1 of the lamp. The other ends of the molybdenum foil members 4 are connected to lead wires 5, which lead wires 5 extend outside the pinch sealed portions 2 of the quartz glass bulb 1 of the lamp. The two lead wires 5 can be connected to an electric current source, so that electric current can be fed to the electrode rods 3 through the molybdenum foil members 4 in order to generate a gas discharge in the gas discharge space 8 of the bulb 1 of the lamp.

Such a gas discharge results in light emission, but also in a large temperature increase of the electrode rods 3 and the material of the bulb 1 of the lamp. As the thermal expansion of the tungsten material of the electrode rod is larger than the thermal expansion of the quartz glass material of the bulb 1 of the lamp when the temperature is rising, high stresses will occur in the materials, in particular tensile stress in the quartz glass material of the bulb 1 of the lamp. Such stresses may result in early lamp failure due to rupture of the bulb 1 of the lamp.

In order to reduce the risk of early lamp failure, at least a part of the surface of the electrode rod 3 is provided with longitudinal grooves 6, i.e. grooves substantially parallel to the axis of the electrode rod 3, as is shown in FIGS. 2a and 2b. FIG. 2a is a sectional view of the electrode rod 3 taken along the line B-B in FIG. 1. In the Figures, the whole circumferential surface of the electrode rod 3 is provided with grooves 6, but alternatively only a part of the surface may be provided with grooves, which part is in contact with the quartz glass material of the bulb 1 of the lamp. Positive results are also obtained in case only a portion of the part of the surface that is in contact with the quartz glass material is provided with grooves 6.

Each of the FIGS. 3a, 3b and 3c shows an electrode rod 3 that is provided with an electrode coil 7 near the tip 9 of the electrode rod 3, i.e. the end of the electrode rod 3 extending into the gas discharge space 8. The electrode coil 7 may be made of the same material as the electrode rod 3, in particular tungsten. The purpose of the electrode coil 7 is to increase the diameter of the electrode rod 3, so that the surface of the electrode 3 is enlarged. Thereby, the heat radiation from the electrode rod 3 is increased in order to reduce the temperature of the electrode rod 3. In general, the electrode coil 7 is located in the gas discharge space 8, but a portion of the electrode coil 7 may be embedded in the quartz glass material of the bulb 1 of the lamp.

FIG. 3a shows diagrammatically an electrode rod 3, wherein the part of the electrode rod 3 situated at the left of the electrode coil 7 will be embedded in the quartz glass material of the bulb 1 of the lamp. The main portion 10 of that part is provided with longitudinal grooves 6 and a small portion 11 is not provided with longitudinal grooves 6. FIG. 3b shows an electrode rod 3, wherein the entire part situated at the left of the electrode coil 7 is provided with longitudinal grooves 6, so that the part of the electrode rod that is embedded in the quartz glass material is completely provided with longitudinal grooves 6. FIG. 3c shows an electrode rod 3, wherein part 12 at the end of the electrode rod 3 that is connected to the molybdenum foil member 4 is not provided with longitudinal grooves 6. That part 12 of the electrode rod 3 has a relatively low temperature during operation compared to other parts of the electrode rod 3.

FIG. 4 shows a lamp assembly 15, i.e. a unit of a high pressure discharge lamp 16 and a reflector 17, in a sectional view. The reflector 17 is mainly made of glass (glass, glass-ceramic or quartz), is bell-shaped, and its central axis 18 extends in the plane of the drawing. The reflector 17 is provided with a light reflecting coating 19 on its parabola-shaped (or elliptical) inner surface. A high pressure gas discharge lamp 16 is mounted in the reflector 17, so that the gas discharge space 20 of the bulb of the lamp 16 is located near the focal point of said parabolic (or elliptical) shape of the reflector 17. Inside the gas discharge space 20 are two electrode rods 21,22, each being electrically connected through a molybdenum foil member 23,24 with a lead wire 25,26 in order to supply electric current to the electrode rods 21,22. Each molybdenum foil 23,24 is located in a pinch sealed portion 27,28 of the bulb of the lamp 16, the two pinch sealed portions 17,18 extending outwardly in opposite directions.

The lamp 16 is attached to the reflector 17 through one of the pinch sealed portions 27, which pinch sealed portion 27 is embedded in cement 29 that is present in the neck portion 30 of the reflector 17. The cement 29 provides for a non-detachable and solid connection between the reflector 17 and the lamp 16, whereby the gas discharge space 20 is kept exactly at the desired location, in order to obtain a predetermined shape of the light beam produced by the lamp assembly 15. The other pinch sealed portion 28 extends along the central axis 18 of the parabolic (or elliptical) shape of the reflector 17.

Electric current is supplied to electrode rod 22 through supply wire 31. One end of supply wire 31 is connected to the lead wire 26 and the other end is connected to first contact element 33 at the backside of reflector 17. Electric current is supplied to electrode rod 21 through second contact element 34 that is also situated at the backside of the reflector 17, which contact element 34 is connected to lead wire 25. The front side of the lamp assembly 15 is covered with a glass plate 32, so that the space inside the reflector 17 is closed.

A main part of the surface of the electrode rods 21,22 of the lamp 16 is provided with longitudinal grooves, for example as is shown in FIG. 3b.

The embodiments of the gas discharge lamp as described above are only examples; many other embodiments are possible.

1. An electric lamp provided with a bulb (1) of quartz glass and a metal electrode rod (3;21,22), which electrode rod (3;21,22) is at least partly embedded in the quartz glass material of the bulb (1), characterized in that at least a major part of the surface of the electrode rod (3;21,22) that is in contact with the quartz glass material is provided with grooves (6) having a substantially longitudinal direction.

2. A lamp as claimed in claim 1, characterized in that the metal material of the electrode rod (3;21,22) comprises tungsten for at least 70% by weight.

3. A lamp as claimed in claim 1, characterized in that the depth of the grooves (6) is more than 1 μm, preferably between 2 μm and 30 μm, more preferably between 3 μm and 20 μm, and still more preferably between 5 μm and 10 μm.

4. A lamp as claimed in claim 1, characterized in that the width/depth ratio of the grooves (6) is less than 4, preferably less than 2, more preferably less than 1.

5. A lamp as claimed in claim 1, characterized in that the number of grooves (6) in a cross section of the electrode rod (3;21,22) is between 10 and 4000 times the diameter of the electrode rod (3;21,22) measured in mm, preferably between 100 and 2000 times, and more preferably between 250 and 1000 times the diameter of the electrode rod (3;21,22) measured in mm.

6. A lamp as claimed in claim 1, characterized in that in a cross section of the electrode rod (3;21,22) the grooves (6) are circumferentially distributed at angles of (360/n)° plus or minus (360/2n)°, where n is the number of grooves (6) in said cross section.

7. A lamp as claimed in claim 1, characterized in that the angles between the longitudinal axis of the electrode rod (3;21,22) and the grooves (6) are less than 20°, preferably less than 10°, more preferably less than 4°.

8. A lamp as claimed in claim 1, characterized in that the lamp is a high pressure gas discharge lamp.

9. A lamp as claimed in claim 1, characterized in that the electrode rod (3;21,22) is present in the pinch sealed portion (2;27,28) of the quartz glass bulb (1) of the lamp.

10. A unit of a lamp and a reflector, characterized in that the reflector (17) is provided with a lamp (16) as claimed in claim 1.

11. A method of manufacturing an electric lamp provided with a bulb (1) of quartz glass and a metal electrode rod (3;21,22), wherein a part of the electrode rod (3;21,22) is embedded in the quartz glass material of the bulb (1), characterized in that, before the electrode rod (3;21,22) is embedded in the quartz glass material, at least a major part of the surface of the electrode rod (3;21,22) that will be in contact with the quartz glass material is provided with grooves (6) having a substantially longitudinal direction.
